(19) United States
(12) Patent Application Publication
(10) Pub. No.: US 2024/0230028 A1
(43) Pub. Date: Jul. 11, 2024

(54) PHASE CHANGE ACCUMULATOR

(71) Applicant: Advanced Energy Storage, LLC, Sandusky, OH (US)

(72) Inventor: Jamie A. M. O'Brien, La Salle, MI (US)

(21) Appl. No.: 18/410,428

(22) Filed: Jan. 11, 2024

Related U.S. Application Data
(60) Provisional application No. 63/438,371, filed on Jan. 11, 2023.

(51) Int. Cl. F17C 1/00

(52) U.S. Cl. CPC F17C 1/00; F17C 2201/0119; F17C 2203/0631; F17C 2205/0149; F17C 2205/0311; F17C 2205/0335; F17C 2221/012; F17C 2227/0142

(57) ABSTRACT

A phase change accumulator assembly includes an inner pressure vessel, an outer pressure vessel, and at least one intermediate pressure vessel. The inner, the at least one intermediate, and the outer pressure vessels are nested concentrically such that the at least one intermediate pressure vessel is within the outer pressure vessel, and the inner pressure vessel is within the at least one intermediate pressure vessel.

### BACKGROUND OF THE INVENTION

This invention relates in general to pressurized fluid storage devices generally, and in particular to phase change accumulators capable of operating across a wide range of temperatures and increased pressure, a lower and controlled differential pressure, and to capture energy in multiple forms.

Accumulators are known to store fluids, particularly fluids considered to be incompressible, under pressure for controlled release.

If the absolute pressure for any material used in a known accumulator is exceeded, any part made from that material will likely fail. Also, known accumulators include high-pressure accumulators that are capable of handling internal pressures exceeding 210 MPa.

It is known that regardless of the material from which pressure vessels in pressurized fluid storage devices are formed, a pressure vessel, like a balloon with a low elasticity skin, will expand slightly as pressure increases. This expansion or change in dimension of the pressure vessel may be substantial enough to cause seals and pistons of accumulators to fail by leaking internally.

For storage of some fuels that exist as gas within the earth's atmosphere it is common to contain them using refrigeration to cryogenic levels, or about −150º C (−238° F.) to absolute zero (−273° C. or −460° F.). This allows the material to remain stable in a desired phase between gas, liquid, and solid. There is an on-going need to consume energy to maintain storage at low temperatures. Additionally, to maintain the low temperatures, a controlled leak may be introduced to vent expanding gas, thus reducing the material being stored. Many materials may be stored at desired phase within the normal swing of the earth's atmospheric pressure and at temperatures within the range of about 60° C. to about −90° C. Large differential pressure experienced during charging and discharging of low temperature gas for example, is known to create significant stress on the pressure vessel causing it to fatigue after a low number of charge and discharge cycles.

It is therefore desirable to provide an accumulator that is configured to operate across a wide range of temperatures and increased pressure, a lower and controlled differential pressure, and to capture energy in multiple forms.

### SUMMARY OF THE INVENTION

This invention relates in general to pressurized fluid storage devices generally, and in particular to phase change accumulators capable of operating across a wide range of temperatures and increased pressure, a lower and controlled differential pressure and to capture energy in multiple forms.

In one embodiment, a phase change accumulator assembly includes an inner pressure vessel, an outer pressure vessel, and at least one intermediate pressure vessel. The inner, the at least one intermediate, and the outer pressure vessels are nested concentrically such that the at least one intermediate pressure vessel is within the outer pressure vessel, and the inner pressure vessel is within the at least one intermediate pressure vessel.

In another embodiment, a phase change accumulator assembly includes an inner pressure vessel, an outer pressure vessel, at least one intermediate pressure vessel, and a piston slidably mounted within the inner pressure vessel. The inner, the at least one intermediate, and the outer pressure vessels are nested concentrically such that the at least one intermediate pressure vessel is within the outer pressure vessel, and the inner pressure vessel is within the at least one intermediate pressure vessel. A portion of the interior of the inner pressure vessel defines a fluid volume, and wherein the piston slidably mounted within the inner pressure vessel is movable against the fluid volume.

Various aspects of this invention will become apparent to those skilled in the art from the following detailed description of the preferred embodiment, when read in view of the accompanying drawings.

### BRIEF DESCRIPTION OF THE DRAWINGS

FIG. 1 is a perspective view of a first embodiment of a phase change accumulator according to this invention.

FIG. 2 is side elevational view of the phase change accumulator illustrated in FIG. 1.

FIG. 3 is a cross-sectional view taken along the line 3-3 of FIG. 2.

FIG. 4 is a cross-sectional view taken along the line 4-4 of FIG. 2.

FIG. 5 is a cross-sectional view taken along the line 5-5 of FIG. 2.

FIG. 6 is a cross-sectional view of a second embodiment of a phase change accumulator according to this invention.

FIG. 7 is graph showing the relationship of pressure and temperature in the phase change accumulator illustrated in FIGS. 1 through 5.

### DETAILED DESCRIPTION OF THE PREFERRED EMBODIMENT

The embodiments of the phase change accumulator shown and described herein advantageously include one or more pressure vessels able to reach pressures of 670 MPa or greater. The phase change accumulators 10 and 100 described herein, create an operating environment where almost every known gas may be stably converted to a supercritical state over a wide range of exterior temperatures. This further allows energy to be stored and available without the need for external power to keep the gas or other material stable.

Depending on the gas or material contained within the accumulator, energy may be extracted mechanically as the phase changes through decompression, with the exhaust being used as fuel to power various engines, including but not limited to, internal combustion engines (ICE), turbines, bell-nozzles, rams, and aerospike style engines. Additionally, such a phase change accumulator will reduce or eliminate the need for toxic chemical energy storage to be carried on board. This structure also significantly increases the efficiency of the energy stored as neither the mechanical energy stored, or the reactive energy of the material stored, is wasted. In circumstances wherein waste heat is available to add to the phase change, even greater efficiencies may be realized.

In its simplest configuration, the phase change accumulator may include a pressure vessel having one or more additional pressure vessels positioned or nested therein. In an accumulator where all the pressure vessels contain the same material, check valves may be built into each pressure vessel to prevent exterior pressure from crushing the inner-most pressure vessel should the inner pressure exceed pre-determined safety margins, A second set of valves may be provided to vent material back into a lower pressure vessel until the lowest pressure vessel protects itself by venting to a predetermined exhaust path.

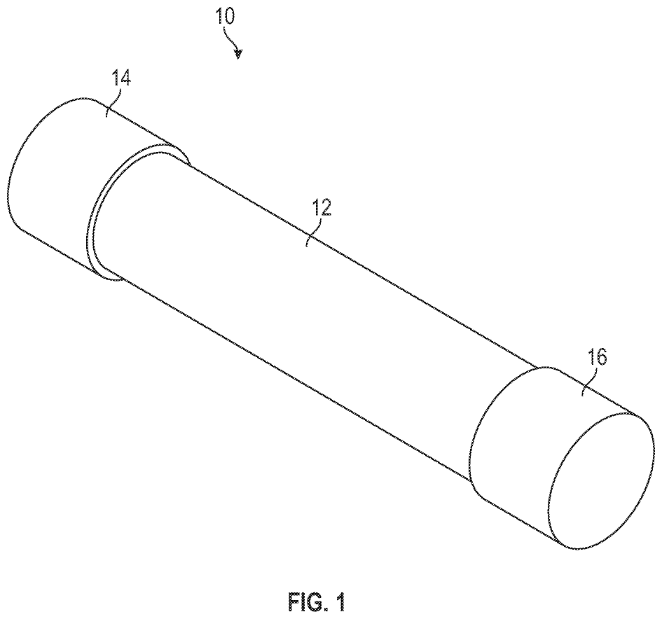

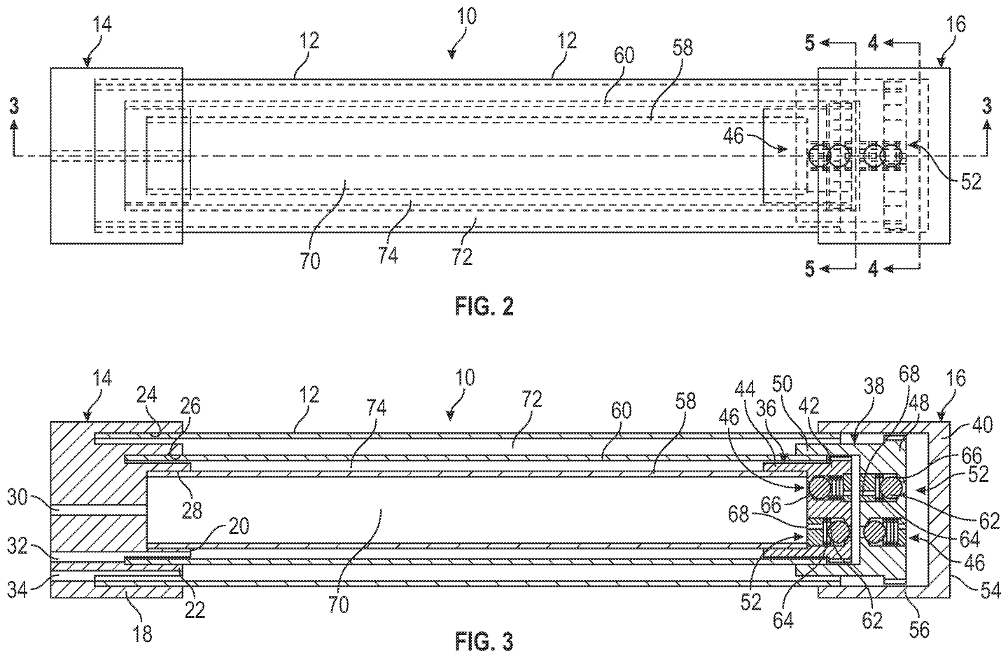

Referring now to the drawings, there is illustrated in FIGS. 1 through 5 a first embodiment of a phase change accumulator shown at 10. The phase change accumulator 10 includes three concentrically mounted cylindrical sleeves or shells mounted between a first end cap 14 and a second end cap assembly 16. A first or external cylindrical shell 12 is visible in FIG. 1 and defines an external surface of the phase change accumulator 10.

The illustrated first end cap 14 has three concentric cylindrical walls, including a first or outer cylindrical wall 18, as second or inner cylindrical wall 20 and a third or intermediate cylindrical wall 22. The outer cylindrical wall 18 and the intermediate cylindrical wall 22 define a first cylindrical groove 24. Similarly, the intermediate cylindrical wall 22 and the inner cylindrical wall 20 define a second cylindrical groove 26. An inside surface of the inner cylindrical wall 20 defines a cylindrical cavity 28. A plurality of longitudinally extending fluid conduits is formed in the first end cap 14. In the illustrated embodiment, three longitudinally extending fluid conduits are shown, including a first longitudinally extending fluid conduit 30, a second longitudinally extending fluid conduit 32, and a third longitudinally extending fluid conduit 34.

The second end cap assembly 16 includes an inner end cap 36, an outer end cap 40, and an intermediate end cap 38 positioned intermediate the inner end cap 36 and the outer end cap 40.

The inner end cap 36 is generally cup shaped and has an end wall 42 and a cylindrical wall 44 extending outwardly from the end wall 42. A pair of pre-loaded, normally closed check valves are mounted in the end wall 42, including a first check valve 46 and a second check valve 52. The operation of the check valves 46 and 52 is discussed below.

The intermediate end cap 38 is similar to the inner end cap 36 and is generally cup shaped, has an end wall 48, and a cylindrical wall 50 extending outwardly from the end wall. A pair of the pre-loaded, normally closed check valves, including the first check valve 46 and the second check valve 52, are mounted in the end wall 42. The operation of the check valves 46 and 52 is discussed below.

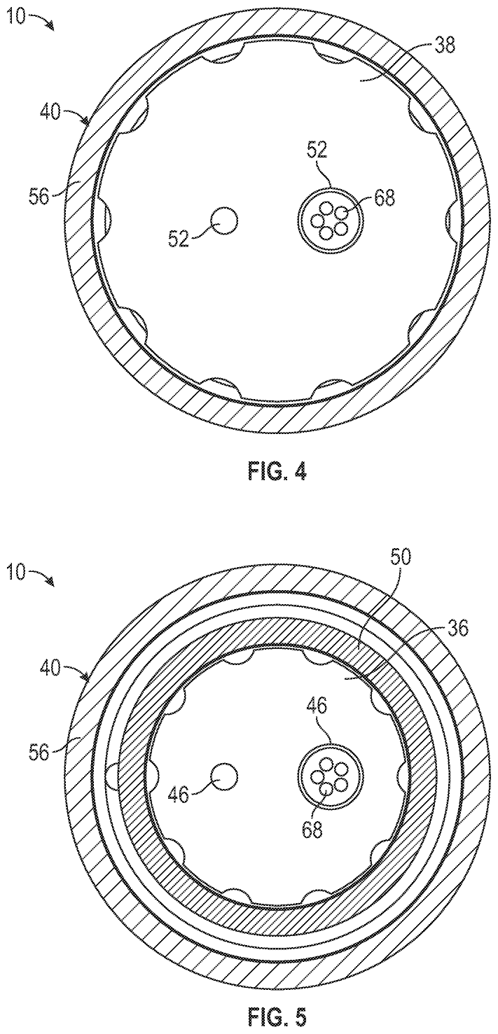

The illustrated check valves 46 and 52 are ball check valves having a ball 62 and a spring 64 that presses the ball 62 into a valve seat 66 at a first end of each check valve 46 and 52. A second end of each check valve 46 and 52 includes a plurality of fluid flow conduits 68, as best shown in FIGS. 4 and 5. It will be understood however, that other types of check valves may be used.

As best shown in FIG. 3, a first end (the left end when viewing FIG. 3) of the external cylindrical shell 12 is mounted to an outboard side of the first cylindrical groove 24. A first end (the left end when viewing FIG. 3) of a second or inner cylindrical shell 58 is mounted to the inside surface of the cylindrical cavity 28. A first end (the left end when viewing FIG. 3) of a third or intermediate cylindrical shell 60 is mounted to an outboard side of the second cylindrical groove 26.

In the illustrated embodiment, the first ends of the external cylindrical shell 12, the inner cylindrical shell 58, and the intermediate cylindrical shell 60 are respectively mounted to the first end cap 14 by press fit, wherein the press fit arrangement defines a high pressure fluid-tight seal. Alternatively, the external cylindrical shell 12, the inner cylindrical shell 58, and the intermediate cylindrical shell 60 may be attached by other means including, but not limited to, welding, brazing, a threaded attachment, and with adhesive. Additionally, seals, such as metal seals and polymer seals, may be mounted between the first ends of the external cylindrical shell 12, the inner cylindrical shell 58, and the intermediate cylindrical shell 60 and the respective portions of the first end cap 14 to which the cylindrical shells 12, 58, and 60 are attached.

Referring again to FIG. 3, a second end (the right end when viewing FIG. 3) of the inner cylindrical shell 58 is mounted to the inside surface of the cylindrical wall 44 of the inner end cap 36. A second end (the right end when viewing FIG. 3) of the intermediate cylindrical shell 60 is mounted to the inside surface of the cylindrical wall 50 of the intermediate end cap 38. A second end (the right end when viewing FIG. 3) of the external cylindrical shell 12 is mounted to the inside surface of the cylindrical wall 56 of the outer end cap 40.

The inner end cap 36 is thus mounted to the inner cylindrical shell 58 such that a high pressure, fluid-tight seal is formed therebetween, and such that the inner end cap 36 defines a high pressure, fluid-tight seal between an inner pressure vessel 70 and an intermediate pressure vessel 74. Additionally, the inner end cap 36 is mounted such that it may slide relative to the intermediate pressure vessel 74 to allow for dimensional changes, such as expansion that may occur as relative pressure between the inner and intermediate pressure vessels 70 and 74 change during charging and discharging cycles of the phase change accumulator 10.

Similarly, the intermediate end cap 38 is mounted to the intermediate cylindrical shell 60 such that a high pressure, fluid-tight seal is formed therebetween, and such that the intermediate end cap 38 defines a high pressure, fluid-tight seal between the intermediate pressure vessel 74 and an outer pressure vessel 72. Additionally, the intermediate end cap 38 is mounted such that it may slide relative to the outer pressure vessel 72 to allow for dimensional changes, such as expansion, that may occur as relative pressure between the outer and intermediate pressure vessels 72 and 74 change during charging and discharging cycles of the phase change accumulator 10. Advantageously, it will be understood that when the differential pressure is lowered, more options for sealing between the shells 12, 58, and 60 and the end caps 14 and 16 become available.

As discussed above, the ends of the external cylindrical shell 12, the inner cylindrical shell 58, and the intermediate cylindrical shell 60 may be mounted to the first end cap 14 and the second end cap assembly 16 by various means, including by press fit, welding, brazing, a threaded attachment, and with adhesive. As shown in FIG. 3, the inner cylindrical shell 58 is attached only to the first end cap 14 and to the cylindrical wall 44 of the inner end cap 36. The inner end cap 36 is then able to float or move within the open end of the intermediate end cap 38 as variations in pressure and temperature cause dimensional changes.

Similarly, the intermediate cylindrical shell is attached only to the first end cap 14 and to the cylindrical wall 50 of the intermediate end cap 38. The intermediate end cap 38 is then able to float or move within an open end of the outer end cap 40 as variations in pressure and temperature cause dimensional changes.

For example, if the pressure within the inner pressure vessel 70 varies between 70 MPa and 80 MPa, and the pressure within the intermediate pressure vessel 74 varies between 70 MPa and 60 MPA, then when the intermediate pressure vessel 74 is at 60 MPa, it is at its smallest size. At the same time however, the pressure within the inner pressure vessel 70 may be at 80 MPa, and thus at its largest size. If the inner pressure vessel 70 was not allowed to float relative to the intermediate end cap 38, stress from expansion of the inner pressure vessel 70 would propagate through the intermediate end cap 38 and the second end cap assembly 16, thus potentially damaging the phase change accumulator 10. Advantageously, because the inner end cap 36 can float within the open end of the intermediate end cap 38 as variations in pressure and temperature cause dimensional changes, modeling of the stresses for safe operation is possible.

The external cylindrical shell 12, the inner cylindrical shell 58, and the intermediate cylindrical shell 60 may be formed from rigid, light-weight gas-impermeable material. Materials from which the illustrated shells 12, 58, and 60 may be formed include, but are not limited to steel, fiberglass, composites, and other metals. Each of the shells 12, 58, and 60 may be wrapped with carbon fiber to define a carbon fiber layer. Such a carbon fiber layer improves hoop strength, improves structural integrity, and improves gas-impermeability of the shells 12, 58, and 60, thus preventing gas from the pressure vessels 70, 72, and 74, described below, from escaping to an exterior of the phase change accumulator 10.

As shown in FIG. 3, the space within the inner cylindrical shell 58 defines the inner pressure vessel 70 that is configured to contain gas having the highest relative pressure in the phase change accumulator 10. The space between the external cylindrical shell 12 and the intermediate cylindrical shell 60 defines the outer pressure vessel 72 that is configured to contain gas having the lowest relative pressure in the phase change accumulator 10. Each of the pressure vessels 70, 72, and 74 is charged with a compressible medium, such as an inert gas like nitrogen (N2), though any suitable gas may be used. Alternative gas and materials that may be used include, but are not limited to, hydrogen gas in fuel energy applications, and nitrogen gas, carbon dioxide gas, and any gas that may be compressed and then release energy, in mechanical energy applications.

The space between the inner cylindrical shell 58 and the intermediate cylindrical shell 60 defines the intermediate pressure vessel 74 that is configured to contain gas having a pressure between the lowest relative pressure and the highest relative pressure in the phase change accumulator 10. Although only one intermediate cylindrical shell 60 is shown in the embodiment illustrated in FIG. 3, it will be understood that the phase change accumulator 10 may include more than one intermediate cylindrical shells 60, thus defining more than one intermediate pressure vessels 74, depending on a desired differential pressure (ΔP) between the lowest relative pressure and the highest relative pressure in the phase change accumulator 10.

The first pair of pre-loaded, normally closed check valves 46 are configured to allow gas to escape from the inner pressure vessel 70, which is configured to contain gas having the highest relative pressure, to the outer pressure vessel 72, which is configured to contain gas having the lowest relative pressure, if the differential pressure between the inner pressure vessel 70 and the outer pressure vessel 72 becomes too high, thus preventing failure and/or damage to the inner pressure vessel 70.

The second pair of pre-loaded, normally closed check valves 52 are configured to allow gas to escape from the outer pressure vessel 72, if the pressure in the inner pressure vessel 70 drops below the pressure in the outer pressure vessel 72 to prevent failure and/or damage to the inner pressure vessel 70.

As shown in FIG. 3, the first end cap 14 includes the first longitudinally extending fluid conduit 30 that extends from an outer end surface of the first end cap and the inner pressure vessel 70, the second longitudinally extending fluid conduit 32 that extends from the outer end surface of the first end cap and the intermediate pressure vessel 74, and the third longitudinally extending fluid conduit 34 that extends from the outer end surface of the first end cap and the outer pressure vessel 72. The first end cap 14 is thus configured to facilitate charging and discharging the phase change accumulator 10 via the fluid conduits 30, 32, and 34.

The fluid conduits 30, 32, and 34 may be connected to external devices such as pump-motors, sterling motors, and other devices configured to manage balanced pressure between the pressure vessels as fuel is consumed. Alternatively, features or devices, such as any of the above mentioned devices, such as pump-motors, sterling motors, and other devices configured to manage balanced pressure between the pressure vessels as fuel is consumed, may be packaged within the first end cap 14 to reduce complex plumbing outside of the first end cap 14, and that may be subject to failure.

In operation, the phase change accumulator 10 may receive gas via the fluid conduits 30, 32, and 34. For example, pressurized gas, such as hydrogen gas, may be introduced into the outer pressure vessel 72 via the fluid conduit 34. The first check valves 46 allow the hydrogen gas to charge at the same pressure less a small difference introduced by the springs 64 in the check valves 46 until the outer pressure vessel 72 reaches its maximum pressure. As, hydrogen gas continues to be pushed into the outer pressure vessel 72, a pump (not shown) begins to pull hydrogen gas out of the outer pressure vessel 72 and pump it into the intermediate pressure vessel 74. The intermediate pressure vessel 74 and the inner pressure vessel 70 continue to charge together until the intermediate pressure vessel 74 reaches it maximum pressure. A second pump (not shown) continues to charge the inner pressure vessel 70 until it reaches its full pressure, and the system is fully charged. It should be noted that once the compressed hydrogen gas cools, the pressure vessels 70, 72, and 74 may be topped off until the system is fully charged and at ambient pressure. Alternatively, each of the pressure vessels 70, 72, and 74 may be charged from the atmosphere via the fluid conduits 30, 34, and 32, respectively.

One key to the successful operation of a phase change accumulator, such as the phase change accumulator 10, is knowing the difference between absolute and relative pressures. If the absolute pressure for any material used in the accumulator is exceeded, any part made from that material will likely fail. However, advanced materials, such as for example nickel and hydrogen, have properties that allow them to be held in a non-karyogenic super critical state stably at temperatures ranging from −88 C to 60 C, a temperature range that is equivalent to the lowest and the highest temperatures, respectively, recorded on earth.

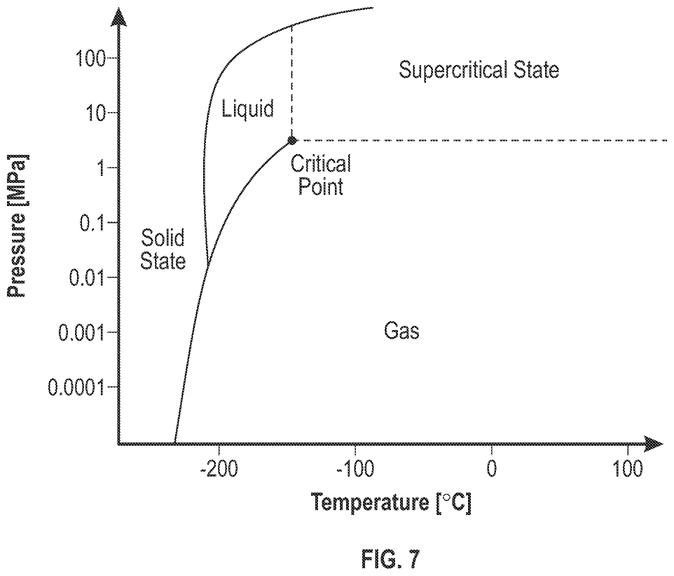

FIG. 7 is a phase change diagram that illustrates material phase change at increasing temperatures and increasing relative pressures. As shown, increasing pressure on a gas will initiate phase change. Increased pressure may then be used to maintain a desired phase.

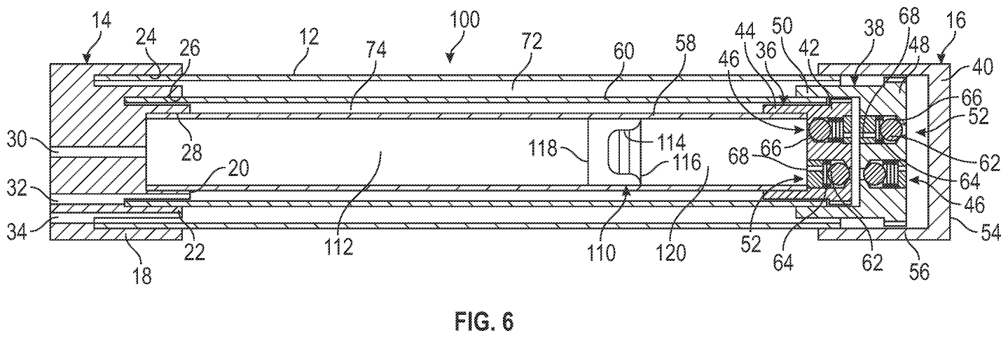

Referring now to FIG. 6, a second embodiment of the phase change accumulator is shown at 100. The phase change accumulator 100 is otherwise the same as the phase change accumulator 10 but includes a piston 110 within the inner cylindrical shell 58. A portion of the interior of the inner cylindrical shell 58 (the portion to the left when viewing FIG. 6) defines a fluid volume 112. The piston 110 mounted within the inner cylindrical shell 58 is movable against the fluid volume 112.

The illustrated piston 110 is a substantially cup-shaped cylindrical piston having an inner surface defining an axial bore 114 extending from a first or open end 116 to a second or closed end 118 of the piston 110. The piston 110 is slidably received within the inner cylindrical shell 58. The piston 110 and the inner cylindrical shell 58 cooperate to separate a gas volume 120 from the fluid volume 112 within the inner cylindrical shell 58. The piston 110 may include an O-ring (not shown) in a circumferential groove (not shown) formed in an outer surface of the piston 110. The O-ring (not shown) is structured and configured to fluidly seal between the piston 110 and the inner surface of the inner cylindrical shell 58.

Advantageously, both the phase change accumulator 10 and the phase change accumulator 100 may operate over a broad range of pressures, including at very high pressures wherein a phase change is initiated, and pressures that are high, but below the pressure values necessary to initiate phase change.

Advantageously, it has been shown that the nested pressure vessels, such as the pressure vessels 70, 72, and 74, do not need to be symmetrical, or have any specific size relative to each other beyond that which is needed to maintain a pressure balance that protects each of the inner pressure vessels from being crushed or from rupturing.

In the embodiments of phase change accumulators 10 and 100 described herein, it will be understood that the pressure vessels are optimized for subsequently higher pressures, but that the concept would also work in reverse, wherein the inner pressure vessel 70 may be designed and configured to protect something or someone from a high atmospheric pressure by maintaining a safe pressure in the one or more inner pressure vessels. Applications for such a reverse order pressure change accumulator may include anything that moves from air into the sea or vice versa. This concept may also be used to design light weight structures that need to go vertically deep into fluids or dense gases.

One advantage to the design of the phase change accumulator having several gas layers is that such a design reduces the wear or fretting that may occur when cycling an accumulator having thicker walled pressure vessels. Such wear or fretting may occur when an outer material of an accumulator can manage much less stress cycling than an inner material of the accumulator. Each pressure vessel 70, 72, and 74 is capable of expanding and contracting with the surrounding, interim gas layer or layers serving as a buffer to the deterioration that thicker layers of material may experience over time. The design of the phase change accumulators 10 and 100 also allows efficient use of the mechanical energy in the pressure vessels as the phase change of the material under pressure in the inner pressure vessel 70 to the first of the gaseous states, as more energy may be harvested with each subsequent reduction in pressure.

For example, hydrogen is relatively stable over a wide temperature range when in a supercritical state of relatively low pressures at temperatures as low as −40 C, and is still within the structural limits of the inner pressure vessel 70 at 72 C.

Advantageously, by having a material phase change in an energy capturing mechanism, such as an ICE or a turbine, the phase change is not limited in its rate by the thermal transfer of a cryogenically stored material. Contrary to other uses of super critical gas, such as hydrogen fuel cells, a range of temperature and operational time of the device or system being powered by the phase change accumulator may be optimized by simply allowing the device or system to warm to a desired temperature prior to use. Temperature may also be used to intentionally make the structure unstable creating and endothermic explosive. For example, when the goal is to store as much energy as possible, the heated gas must be allowed to cool and shrink back to ambient temperature, after which the system may be topped off with more gas.

When energy is released from a higher pressure vessel to the next lower pressure vessel, the physical cell the energy is stored in, for example a mechanical device such as a hydraulic motor, may be made to spin and the energy may be collected by a generator or other device so as to create a desired form of energy. Additionally, while the material expands, it must absorb heat, thus making the thermal energy possible to collect.

Additionally, the phase change accumulator 10 may be advantageously used to capture energy in multiple forms. For example, if a combustible fuel is contained within the phase change accumulator 10, energy may be extracted by the mechanical change of pressure from a higher pressure vessel to a lower pressure environment. Further, energy may be extracted by the cooling properties of an expanding material into a gas, such that it is at a low enough pressure that the fuel itself may be burned by known energy conversion devices, such as an internal combustion engine, a fuel cell, and a rocket.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A phase change accumulator, comprising:
an inner pressure vessel;
an outer pressure vessel; and
at least one intermediate pressure vessel;
wherein the inner, the at least one intermediate, and the outer pressure vessels are nested concentrically such that the at least one intermediate pressure vessel is within the outer pressure vessel, and the inner pressure vessel is within the at least one intermediate pressure vessel.

2. The phase change accumulator according to claim 1, wherein the at least one intermediate pressure vessel is a plurality of intermediate pressure vessels.

3. The phase change accumulator according to claim 1, wherein the at least one intermediate pressure vessel is one intermediate pressure vessel.

4. The phase change accumulator according to claim 3, further including a first end cap defining a first end of each of the inner, intermediate, and outer pressure vessels and therefore a first end of the phase change accumulator.

5. The phase change accumulator according to claim 4, further including a second end cap defining a second end of each of the inner, intermediate, and outer pressure vessels and therefore a second end of the phase change accumulator.

6. The phase change accumulator according to claim 5, wherein the second end cap is a second end cap assembly having an inner end cap, an outer end cap, and an intermediate end cap positioned intermediate the inner end cap and the outer end cap.

7. The phase change accumulator according to claim 6, further including:
an external cylindrical shell;
an inner cylindrical shell; and
an intermediate cylindrical shell;
wherein the inner cylindrical shell is mounted with a fluid-tight seal between a first end cap and the inner end cap of the second end cap assembly;
wherein the intermediate cylindrical shell is mounted with a fluid-tight seal between the first end cap and the intermediate end cap of the second end cap assembly;
wherein the external cylindrical shell is mounted with a fluid-tight seal between the first end cap and the outer end cap of the second end cap assembly;
wherein a space within the inner cylindrical shell defines the inner pressure vessel;
wherein a space between the external cylindrical shell and the intermediate cylindrical shell defines the outer pressure vessel; and
wherein a space between the inner cylindrical shell and the intermediate cylindrical shell defines the intermediate pressure vessel.

8. The phase change accumulator according to claim 7,
wherein the inner pressure vessel is configured to contain gas having the highest relative pressure in the phase change accumulator;
wherein the outer pressure vessel is configured to contain gas having the lowest relative pressure in the phase change accumulator; and
wherein the intermediate pressure vessel is configured to contain gas having a pressure between the lowest relative pressure and the highest relative pressure in the phase change accumulator.

9. The phase change accumulator according to claim 8,
wherein the inner end cap is cup shaped having an end wall and a cylindrical wall extending outwardly from the end wall; and
wherein a pair of pre-loaded, normally closed check valves are mounted in the end wall, the pair of check valves including a first check valve configured for fluid flow in a first direction, and a second check valve configured for fluid flow in a second direction.

10. The phase change accumulator according to claim 9,
wherein the intermediate end cap is cup shaped having an end wall and a cylindrical wall extending outwardly from the end wall; and
wherein a pair of the pre-loaded, normally closed check valves are mounted in the end wall, the pair of check valves including the first check valve configured for fluid flow in a first direction, and the second check valve configured for fluid flow in a second direction.

11. The phase change accumulator according to claim 10, wherein the inner end cap of the inner pressure vessel is positioned and configured such when the inner pressure vessel expands during operation of the phase change accumulator, the inner end cap may slide relative to the intermediate pressure vessel and move within move within an open end of the intermediate end cap.

12. The phase change accumulator according to claim 11, wherein the intermediate end cap of the intermediate pressure vessel is positioned and configured such when the intermediate pressure vessel expands during operation of the phase change accumulator, the intermediate end cap may slide relative to the outer pressure vessel and move within move within an open end of the outer end cap.

13. A phase change accumulator, comprising:
an inner pressure vessel;
an outer pressure vessel;
at least one intermediate pressure vessel; and
a piston slidably mounted within the inner pressure vessel;
wherein the inner, the at least one intermediate, and the outer pressure vessels are nested concentrically such that the at least one intermediate pressure vessel is within the outer pressure vessel, and the inner pressure vessel is within the at least one intermediate pressure vessel.

14. The phase change accumulator according to claim 13, wherein a portion of the interior of the inner pressure vessel defines a fluid volume, and wherein the piston slidably mounted within the inner pressure vessel is movable against the fluid volume.

15. The phase change accumulator according to claim 14, wherein the piston a cup-shaped cylindrical piston having an inner surface defining an axial bore extending from a first, open end to a second, closed end of the piston.

16. The phase change accumulator according to claim 15, wherein the piston and the interior of the inner pressure vessel cooperate to separate a gas volume from the fluid volume within the interior of the inner pressure vessel.

17. The phase change accumulator according to claim 16, further including:
a first end cap defining a first end of each of the inner, intermediate, and outer pressure vessels and therefore a first end of the phase change accumulator; and
a second end cap assembly having an inner end cap, an outer end cap, and an intermediate end cap positioned intermediate the inner end cap and the outer end cap.

18. The phase change accumulator according to claim 17, further including:
an external cylindrical shell;
an inner cylindrical shell; and
an intermediate cylindrical shell;
wherein the inner cylindrical shell is mounted with a fluid-tight seal between a first end cap and the inner end cap of the second end cap assembly;
wherein the intermediate cylindrical shell is mounted with a fluid-tight seal between the first end cap and the intermediate end cap of the second end cap assembly;
wherein the external cylindrical shell is mounted with a fluid-tight seal between the first end cap and the outer end cap of the second end cap assembly;
wherein a space within the inner cylindrical shell defines the inner pressure vessel;
wherein a space between the external cylindrical shell and the intermediate cylindrical shell defines the outer pressure vessel; and
wherein a space between the inner cylindrical shell and the intermediate cylindrical shell defines the intermediate pressure vessel.

19. The phase change accumulator according to claim 18,
wherein the inner end cap is cup shaped having an end wall and a cylindrical wall extending outwardly from the end wall;
wherein a pair of pre-loaded, normally closed check valves are mounted in the end wall, the pair of check valves including a first check valve configured for fluid flow in a first direction, and a second check valve configured for fluid flow in a second direction;
wherein the intermediate end cap is cup shaped having an end wall and a cylindrical wall extending outwardly from the end wall; and
wherein a pair of the pre-loaded, normally closed check valves are mounted in the end wall, the pair of check valves including the first check valve configured for fluid flow in a first direction, and the second check valve configured for fluid flow in a second direction.

20. The phase change accumulator according to claim 13,
wherein the inner end cap of the inner pressure vessel is positioned and configured such when the inner pressure vessel expands during operation of the phase change accumulator, the inner end cap may slide relative to the intermediate pressure vessel and move within move within an open end of the intermediate end cap; and
wherein the intermediate end cap of the intermediate pressure vessel is positioned and configured such when the intermediate pressure vessel expands during operation of the phase change accumulator, the intermediate end cap may slide relative to the outer pressure vessel and move within move within an open end of the outer end cap.
